(19) United States
(12) Patent Application Publication
(10) Pub. No.: US 2008/0065928 A1
(43) Pub. Date: Mar. 13, 2008

(54) TECHNIQUE FOR SUPPORTING FINDING OF LOCATION OF CAUSE OF FAILURE OCCURRENCE

(75) Inventors: Yashuhiro Suzuki, Tokyo (JP); Yashuhisa Goto, Kanagawa-ken (JP)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/844,549

(22) Filed: Aug. 24, 2007

(30) Foreign Application Priority Data
Sep. 8, 2006 (JP) 2006-243845

(51) Int. Cl. G06F 11/20; G06F 3/048

(52) U.S. Cl. 714/3; 715/781; 714/E11.071

(57) ABSTRACT

A support system includes a storage unit for storing a dependency graph in which components are expressed as nodes and relationships of components depending directly on each other are expressed with links, a log display unit for displaying, in response to detection of a failing component, a log of events occurring in the component, a selection unit for selecting, in response to an instruction by a user, a component that is adjacent to the failing component on the dependency graph, as a candidate component for a failure cause, and a display control unit for enabling the log display unit to additionally display a log of events occurring in the selected candidate component, wherein the selection unit further selects, in response to an instruction by a user, a component that is adjacent to the candidate component on the dependency graph as a new candidate component on condition that a log thereof has not yet been displayed.

### FIELD OF THE INVENTION

The present invention relates to a technique for supporting finding of a location of a cause of a failure occurrence. Particularly, the present invention relates to a technique for supporting finding of a component that causes a failure occurrence in an information system comprising a plurality of components.

### BACKGROUND ART

Recent information systems are large-scaled and complicated, and when a failure occurs, it is sometimes difficult to find a location of a cause of a failure occurrence. For example, the problem determination for finding a location of a failure cause depends largely on experienced knowledge and trial and error by subject matter experts (SME). As one of approaches of the problem determination by subject matter experts, an analysis of a log of events is performed. The analysis of the log of events is carried out, for example, by carefully investigating a log of events of a component for which a failure is reported, and by checking the contents of any error messages produced before and after the occurrence of the failures

However, in a large, complicated information system, a component in which an occurrence of a failure is reported and a component in which a root cause of the failure exists are frequently different from each other. Therefore, when an expert responsible for a certain component in which a failure occurs has found that there is no root cause regarding the failure, he or she asks another expert responsible for another component to investigate that component. Then, if this expert investigate another component for which he or she is responsible and finds there is no root cause, he or she asks a third expert to perform a like investigation. In this manner, before a cause of the failure has been found, a large number of subject matter experts may have been requested to perform investigations and an extended time may have been required.

Japanese Published Patent Application No. 11-259331 (hereinafter JP '331) discloses a technique related to the detection of a failed location. JP '331 discloses that when a failure occurs during a service in use, a set of services each of which could include a cause of a failure is extracted, by tracing a relationship on a network dependency graph (see, for example, claim 1 of JP '331). Then, services which are normally operating at the time of examining the cause are removed from the set of services, so that the range within which the failure probably lies is gradually narrowed (see, for example, claim 12 of JP '331). Therefore, the technique of JP '331 can limit the range where it is supposed for the failed location to exist therein as small as possible (see, for example, a section of advantages of the invention in JP '331).

According to the technique described in JP '331, the range to be investigated is narrowed based on a current operating state, such as whether services are normally operating. However, since continuous operations are required in most cases for recent information systems, the system is immediately restarted following the occurrence of a failure, so that the system may already operate normally before a search is begun to locate a cause of a failure. Therefore, it is frequently not practical for a current operating state to be employed in the analysis of the failures And in this case, the only data that can be employed while searching for the cause of a failure are those that were collected in the past, such as data previously entered in a log of events. However, in JP '331, the use of such logs is not referred to.

Further, since the technique in JP '331 employs an approach as its base such that at first, a broad range is defined for an area to be investigated, and the range is then gradually narrowed down, a large number of experts might eventually participate in the investigation. Furthermore, the technique described in JP '331 indicates a range within which the cause of a failure is to be investigated, and it cannot indicate, after the range is determined, in what order the range is to be investigated. Thus, the investigation may not be performed efficiently.

### SUMMARY OF THE INVENTION

Therefore, an object of the present invention is to provide a support system, a support method and a support program that can solve the above described problems. This object can be achieved by the combinations of the features described in the independent claims. Further, the dependent claims define useful embodiments of the invention.

To achieve the above-described object, there is provided, according to one aspect of the present invention, a support system for supporting finding of location of a cause of a failure occurrence in an information system that includes a plurality of components, comprising a storage unit for storing a dependency graph in which components are expressed as nodes and relationships of components depending directly on each other are expressed with links, a log display unit for displaying, in response to detection of a failing component, a log of events for the component, a selection unit for selecting, in response to an instruction by a user, a component that is adjacent to the failing component on the dependency graph, as a candidate component for a failure cause, and a display control unit for permitting the log display unit to also display a log of events occurring in the selected candidate component, wherein the selection unit selects, in response to an instruction by a user, a component that is adjacent to the candidate component on the dependency graph, as a new candidate component, on condition that a log thereof has not yet been displayed.

### BRIEF DESCRIPTION OF THE DRAWINGS

FIG. 1 is a diagram showing a connection relationship between an information system 10 and a support system 20 according to one embodiment of the present invention.

FIG. 2 is a diagram showing the functional arrangement of the support system 20.

FIG. 3A is a diagram showing a first example of data stored in a dependency graph storage unit 200.

FIG. 3B is a diagram showing a second example of data stored in the dependency graph storage unit 200.

FIG. 4 is a diagram showing an example of a data structure for a log DB 225.

FIG. 5 is a diagram showing an example of a display provided by a log display unit 220.

FIG. 6 is a flowchart showing a process for gradually extending the range of components for which logs are displayed.

FIG. 7 is a flowchart showing a process for horizontally extending the search range.

FIG. 8 is a flowchart showing a process for vertically extending the search range.

FIG. 9 is a diagram showing an example of display provided by the log display unit 220 according to a modified embodiment of the present invention.

FIG. 10 is a diagram showing an example of a hardware configuration of an information processing system 90 that serves as the support system 20.

### BEST MODE FOR CARRYING OUT THE INVENTION

The present invention will be described by referring to the best mode (hereinafter referred to as an embodiment) for carrying out this invention. However, the present invention as claimed in the appended claims is not limited to the embodiment, and not all the combinations of features explained in the following embodiment are always necessary as means for solving the problems.

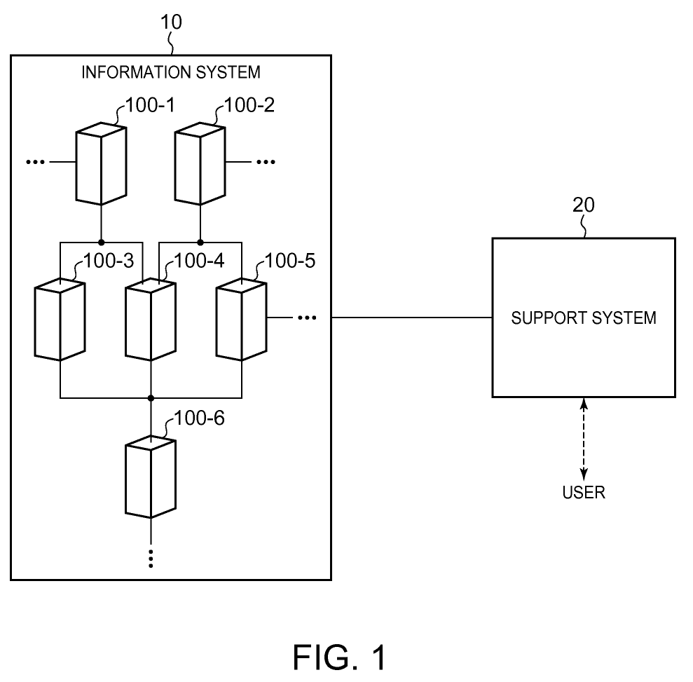

FIG. 1 shows the connection relationship of an information system 10 and a support system 20. The information system 10 includes a plurality of information processing units, e.g., information processing units 100-1 to 100-6. Each of the information processing units 100-1 to 100-6 includes hardware components and software components. The information processing units 100-1 to 100-6 are connected by telecommunication lines to mutually communicate with each other and perform processing. Each of the information processing units 100-1 to 100-6 may be a logical information processing unit that is arranged in a single large general-purpose computer, and employ parts of the computer in a physical division manner or in a time division manner. That is, regardless of their physical forms, the information processing unit in this embodiment is a unit for which a system administrator who detects and repairs a failure in the information system 10 can obtain a log of events, independently of other units, and can cope with a failure therein, independently of coping with failures in the other units.

The information system 10 is connected to the support system 20. The support system 20 collects logs of past events that occurred in the respective components of the information system 10. Further, the support system 20 also detects a failure that occurred in any component of the information system 10. For example, the support system 20 may receive a warning from a failure monitoring system, provided in the information system 10, indicating that a serious failure has occurred.

In this embodiment, the support system 20 is employed with the objective that, when a failure is detected, logs of various events are collected and displayed in the order of their relevancy to the failure, beginning with the nearest, so that a user can efficiently analyze the log of events to find a cause of the failure.

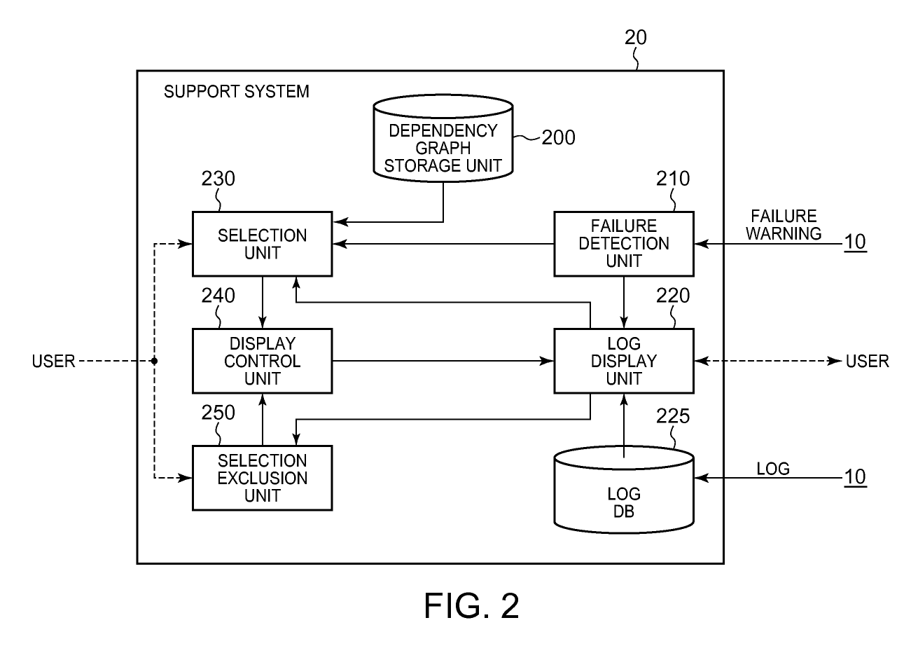

FIG. 2 shows the functional arrangement of the support system 20. The support system 20 includes a dependency graph storage unit 200, a failure detection unit 210, a log display unit 220, a log DB 225, a selection unit 230, a display control unit 240 and a selection exclusion unit 250. The dependency graph storage unit 200 stores a dependency graph in which components are expressed as nodes and relationships of components depending directly on each other are expressed with links. The failure detection unit 210 receives a failure warning from a failure monitoring server or a failure monitoring agent in the information system 10, and detects, based on the failure warning, a component of the information system 10 in which the failure has occurred. The log display unit 220 reads, in response to the detection of the failing component, a log of events occurring in that component, from the log DB 225, and displays the same for a user. The log DB 225 stores logs of events periodically collected by the information system 10, for example, regardless of an occurrence of a failure.

The log display unit 220 accepts an instruction to display logs of other components, from a user who has viewed the log for the failing component. The selection unit 230 selects, in response to a user instruction, a component that is adjacent to the failing component on the dependency graph, as a candidate component for a failure cause. The information for identifying the selected candidate component is output to the display control unit 240, and the display control unit 240 permits the log display unit 220 to further display the log of events occurring in the selected candidate component. The log display unit 220 accepts an instruction for displaying the logs for other components, from the user who has viewed the log for the candidate component. The selection unit 230 selects, in response to this instruction, a component that is adjacent to the candidate component that was previously selected on the dependency graph, as a new candidate component, on condition that a relevant log has not yet been displayed. The log of the newly selected candidate component is displayed on the log display unit 220 by the display control unit 240.

The log display unit 220 may further accept a designation of a component that is to be excluded from the candidate components, from a user. In this case, the selection exclusion unit 250 excludes a component designated by the user among components that have already been selected as candidate components and for which the logs of events are displayed. In response to this, the display control unit 240 deletes the log of the component excluded from the candidate components, from the display of the log display unit 220.

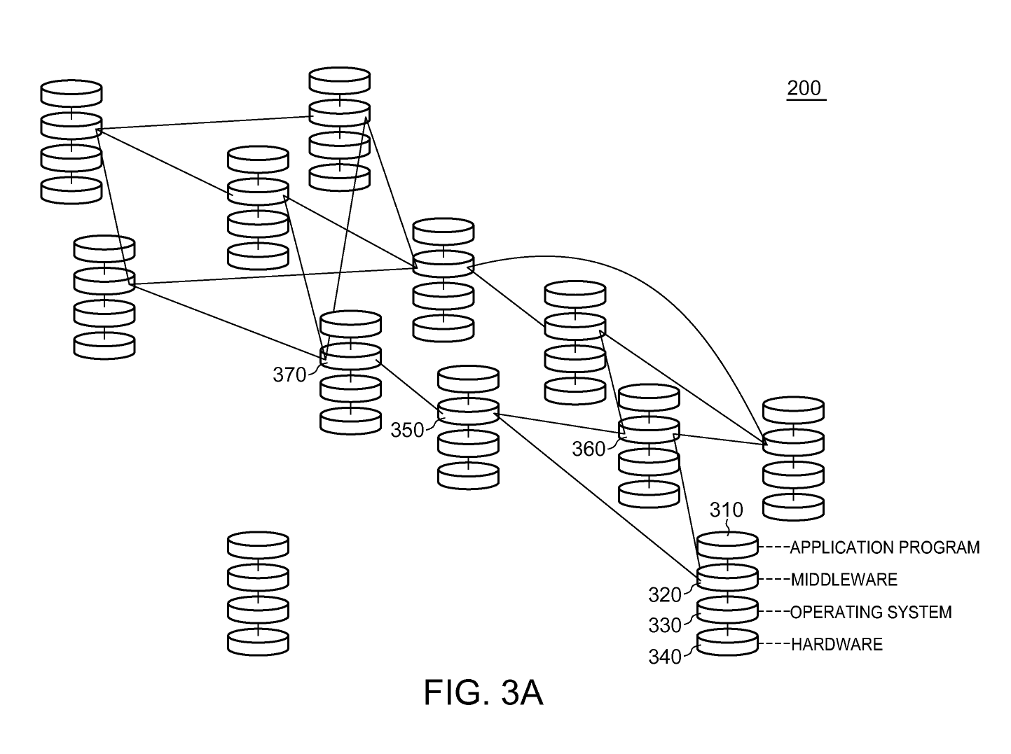

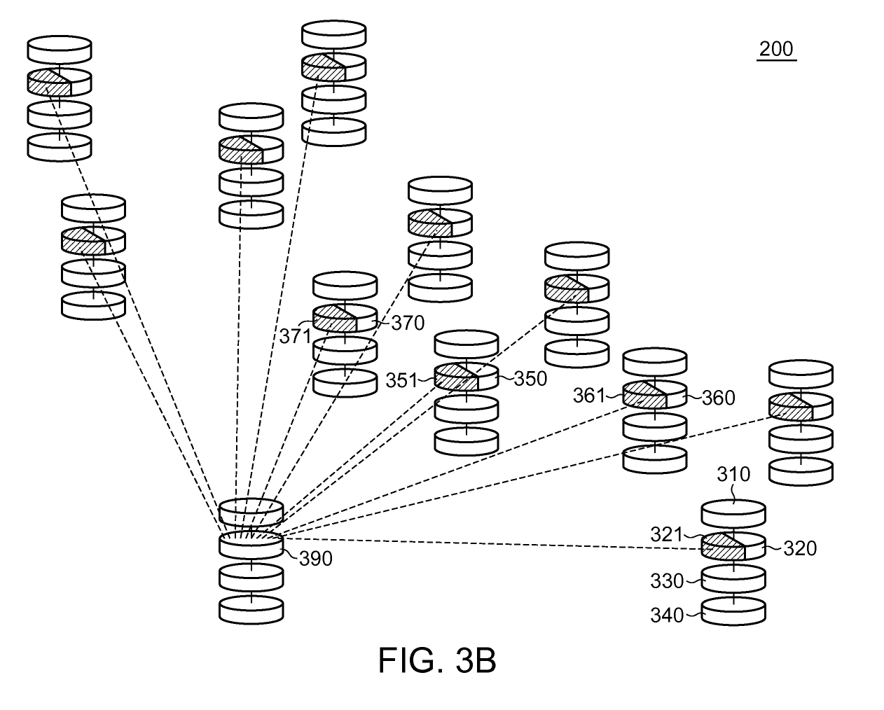

FIG. 3A shows a first example of data to be stored in the dependency graph storage unit 200. In the dependency graph stored in the dependency graph storage unit 200, each node represents a component that serves as at least a part of hardware of one of the information processing units 100, or a component that serves as at least a part of software operating in one of the information processing units 100. More specifically, each node, for example, is a hardware component of an information processing unit 100, an operating system operating on an information processing apparatus 100, a middleware operating on the operating system, or an application program operating on the middleware.

In addition, in the dependency graph stored in the dependency graph storage unit 200, a relationship of components is expressed with a vertical link, which indicates that one component, among a plurality of components operating in the same information processing unit 100, operates in dependence on the operation of another component Specifically, a node 310 represents an application program, a node 320 represents a middleware, a node 330 represents an operating system and a node 340 represents hardware, all of which operate in the same information processing unit 100. Since the application program represented by the node 310 is activated and operated by the middleware represented by the node 320, the node 310 and the node 320 are connected by a vertical link. Likewise, since data are communicated between the middleware and the operating system, the node 320 and the node 330 are connected by a vertical link Further, in the same manner, the node 330 and the node 340 are connected by a vertical link. In FIG. 3A, while only the node 310 is vertically connected above the node 320, a plurality of nodes may be vertically connected above the node 320 when a plurality of application programs run.

As described above, a relationship in which one component among a plurality of components operates in dependence on the operation of another component is, for example, a relationship in which one component serves as a called party and another component is a calling party, or a relationship in which one component and another component send and receive data. The relationship between a calling party and a called party is, for example, a relationship in which components serve as a calling party and a called party for an API (Application Programming Interface) function, and in this case, it is of no concern whether arguments are provided as parameters for calling the function. Further, a relationship in which one component operates in dependence on the operation of another component may, for example, be a relationship between a first component and a second component that is a basic environment for the operation of the first component. This corresponds, for example, to a relationship between an application program and middleware that is the basic environment for the operation of the application program.

Moreover, in the dependency graph stored in the dependency graph storage unit 200, a relationship of a plurality of components that operate in different information processing units 100 and communicate with each other is expressed with a horizontal link. Since the middleware represented by the node 320 communicates with a node 350 that represents another middleware operating in a different information processing unit 100, the node 320 and the node 350 are connected by a horizontal link. Likewise, the node 320 is connected by a horizontal link to a node 360 that represents middleware operating in a different information processing unit 100. Though the middleware represented by the node 320 also communicates with middleware represented by a node 370 via the middleware represented by the node 350, the node 320 and the node 370 are not connected by a link because these nodes do not communicate directly.

More specifically, a relationship in which a plurality of components communicates with each other, for example, is a relationship in which a certain component designates another component as a destination of data transmission, and transmits data to the designated component. Alternatively, a relationship in which components communicate with each other may be a relationship of two components connected via a storage device having transmission lines connected thereto with one component writing data to the storage device and the other component reading the written data from the storage device. In this case, the storage device falls outside the failure detection performed by the support system 20 of this embodiment, and the transmission of data via the storage device is regarded as a relationship in which two components communicate directly with each other. In a further example, a relationship in which a plurality of components communicates with each other may be a relationship in which components operating in the same large general-purpose computer send and receive data via a common memory space. Also, a relationship in which a plurality of components communicate with each other may be a relationship in which, for an NFS network File System), components (operating systems in this case) operating in different information processing units can access the same storage area.

For convenience of explanation, only the horizontal links for connecting components at the middleware level are shown in FIG. 3A. Additional horizontal links may be provided to connect components at the application program level and to connect components at the hardware level. These links indicate wired or wireless connections of communication lines at the hardware level, communication of information as well as a call relationship such as remote procedure call at the middleware level, or communication of information between application programs at the application program level. The communication of information between application programs is actually implemented by an API call to an operating system, and data is communicated between operating systems. However, such communication of data is regarded as communication between application programs, and is not regarded as communication between operating systems. Communication between operating systems is defined as a voluntary communication by one operating system with another operating system, which is not requested by an application program.

As described above, in the dependency graph shown in FIG. 3A, a node represents a component, and a link represents a relationship between a component serving as a communication source and a component serving as a communication destination, or a relationship between a component serving as a data output source and a component serving as a data output destination.

The dependency graph storage unit 200 may additionally store a link representing a relationship in which components depend on each other, in association with an attribute indicating a type of the link. For example, the dependency graph storage unit 200 stores a link representing a relationship in which multiple components operating in different information processing units 100 communicate with each other, in association with an attribute indicating a communication type. The attribute indicating the communication type may, for example, be a communication protocol, a communication frequency, or a volume of data to be transferred. As another example, the dependency graph storage unit 200 may store, as a dependency graph, a directed graph that includes directed links, in addition to undirected links. The directed links indicate directions of communication and/or dependency. That is, when data is transmitted from node A to node B, but data is not transmitted from node B to node A, a directed link from node A to node B is stored. Further, in a case where node A operates in dependence on the operation of node B, a directed link from node A to node B is stored. The latter relationship is, for example, a relationship between a program and the basic environment in which the program runs. Specifically, this corresponds to a relationship between an application program and the middleware that provides the basic environment for the operation of the application program. When a directed link from node A to node B is present, the selection unit 230 determines that node A is adjacent to node B, but node B is not adjacent to node A.

FIG. 3B shows a second example of data to be stored in the dependency graph storage unit 200. In each of the information processing units 100, a program for monitoring operations hereinafter referred to as a monitoring agent) may be running in order to monitor operating states of application programs running in that information processing unit 100, and to determine whether a failure has occurred. Specifically, as shown in FIG. 3B, in an information processing unit 100, in which an application program 310 is running, a monitoring agent 321 is operating to monitor the operation of the application program 310. Likewise, a monitoring agent 351, a monitoring agent 361 and a monitoring agent 371 are operating in other information processing units 100, respectively.

These monitoring agents transmit monitoring results to a monitoring server program 390 running in a different information processing unit 100, so that the monitoring results can be collected by the monitoring server program 390. A transmission relationship for the monitoring results may be stored in the dependency graph storage units 200 as monitoring links so that they can be distinguished from the other links in the dependency graph. These links are indicated by dotted lines in FIG. 3B. Preferably, the selection unit 230 selects, in response to an instruction by a user, one of a monitoring link and other link, and selects a component that is adjacent to the candidate component which is previously selected via the selected link only, as a candidate component. Thus, even when it is determined that abnormality has occurred in an application program due to an abnormal monitoring process or an abnormal notification process for monitoring results, it is possible to narrow locations of a cause of the abnormality, and to efficiently find the cause.

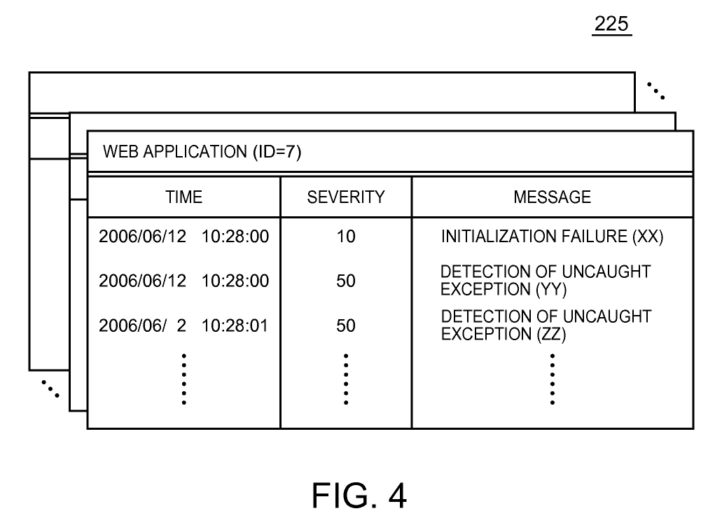

FIG. 4 shows an example of a data structure of the log DB 225. The log DB 225 stores, for each component, a log of events collected from the component. For example, for a web application server program which is one of components, the log DB 225 stores the time of occurrence of an event occurring in the application server program, severity of a failure in the case where the event indicate the failure, and a message describing the contents of the event in a natural language, in association with an identification number 7, which identifies the web application server program. In the illustrated example, initialization for a process XX failed on Jun. 12, 2006 at 10:28:00 in this program, and its severity is 10/100 when this event is regarded as a failure. A failure in this case may include not only a failure detected by the failure detection unit 210, but also a failure for which the severity is so low that the failure detection unit 210 does not detect it.

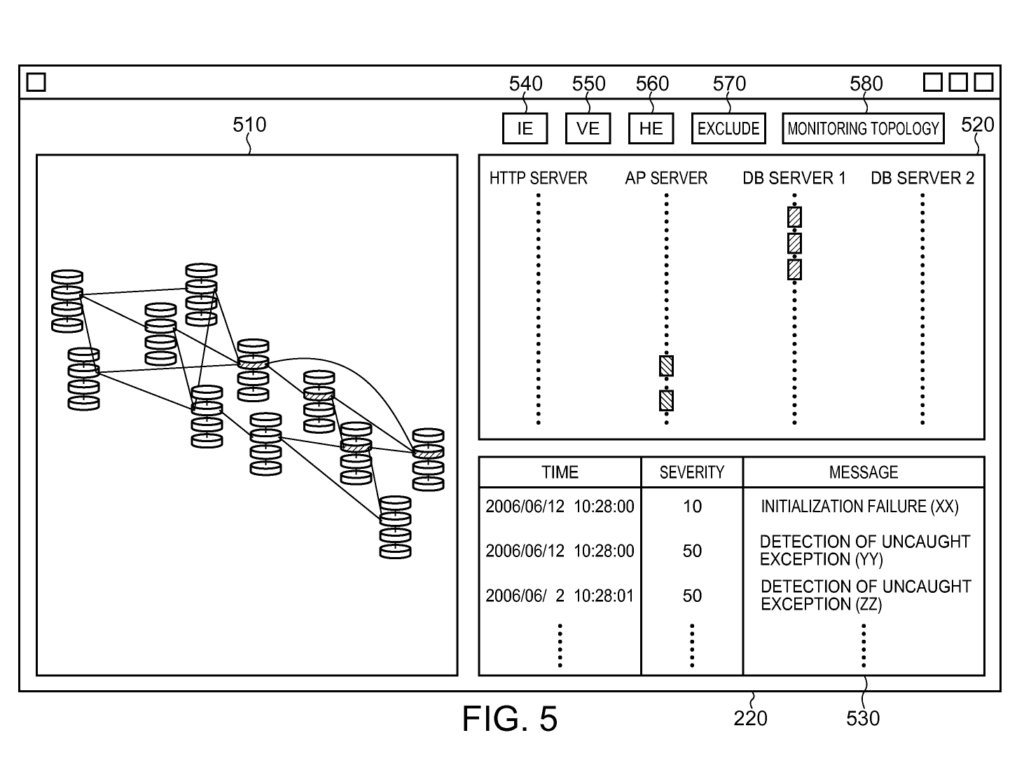

FIG. 5 shows an example of display provided by the log display unit 220. The log display unit 220 displays a topology view 510, a sequence view 520, a table view 530, an instruction button 540, an instruction button 550, an instruction button 560, an instruction button 570 and an instruction button 580. The topology view 510 is used to display a dependency graph stored in the dependency graph storage unit 200. In the dependency graph on the display, a node that represents a component in which a failure is detected is shown with hatching, so that it can be differentiated from the other nodes. Further, a candidate node that has been already selected is also shown with hatching, so that it can be differentiated from the other nodes. The sequence view 520 shows a digest of logs of events for a component in which a failure is detected, and a previously selected candidate component.

Specifically, in the sequence view 520, a log of events is divided into a plurality of log segments with respect to a predetermined period of time, and symbols, which represent the respective log segments and indicate the severity of failures recorded in the log segments, are arranged in the order of occurrence of corresponding events and displayed for each component. For example, for the component of an HTTP server program, since any event did not occur during the predetermined period of time, a rectangular symbol indicating the occurrence of an event is not displayed. On the other hand, for the component of an application server program, since the occurrence of a failure having a comparatively high severity is recorded in the second half of the predetermined period, two rectangular hatched symbols are displayed. A color or a pattern may also be provided for a symbol in consonance with the severity of a failure recorded in the corresponding log.

The table view 530 displays the contents of a log segment that correspond to a symbol selected by a user in the sequence view 520. The displayed log is one covering the predetermined period, e.g., one minute or one hour, and a specific example of the contents thereof is the same as those explained with reference to FIG. 3.

Each of the instruction buttons 540, 550 and 560 is a button for accepting an instruction from a user for searching for a cause of a failure. The instruction button 540 is employed to enter an instruction (IE: Intelligent Expansion) to the effect that a direction for a search will not be designated and that a search range is to be expanded at the discretion of the support system 20. The instruction button 550 is employed to enter an instruction (VE: Vertical Expansion) to search for a failure cause vertically, while the instruction button 560 is employed to enter an instruction (HE: Horizontal Expansion) to search for a failure cause horizontally. For example, the selection unit 230 selects, in response to an instruction entered using the instruction button 550, a component that is adjacent to a component in which a failure occurred or a previously selected candidate component on the dependency graph via a vertical link, as a new candidate component Then, once a selection has been made, the display control unit 240 symbolizes the log of the newly selected candidate component and displays its symbol in the sequence view 520.

The instruction button 570 is a button for accepting an instruction for excluding a designated component from candidate components. For example, when a user designates a certain node in the topology view 510 and selects the instruction button 570, the selection exclusion unit 250 excludes the component represented by the selected node from candidate components. Then, the display control unit 240 removes the log of the excluded component from the sequence view 520 and the table view 530.

The instruction button 580 is a button for accepting an instruction for searching for a failure cause through the monitoring links. For example, when a user selects a certain node in the topology view 510 and selects the instruction button 580, the selection unit 230 selects a monitoring agent that is monitoring the certain node (corresponding to a failing component or a previously selected candidate component). In this case, the monitoring link-based dependency graph shown in FIG. 3B may be displayed in the topology view 510. Then, the selection unit 230 selects a component that is adjacent to the selected monitoring agent on the dependency graph via the monitoring link, as a candidate component. Through this process, when the occurrence of a failure in the monitoring system is suspected in the investigation of the failure cause, the topology of the dependency graph used for the search can be changed.

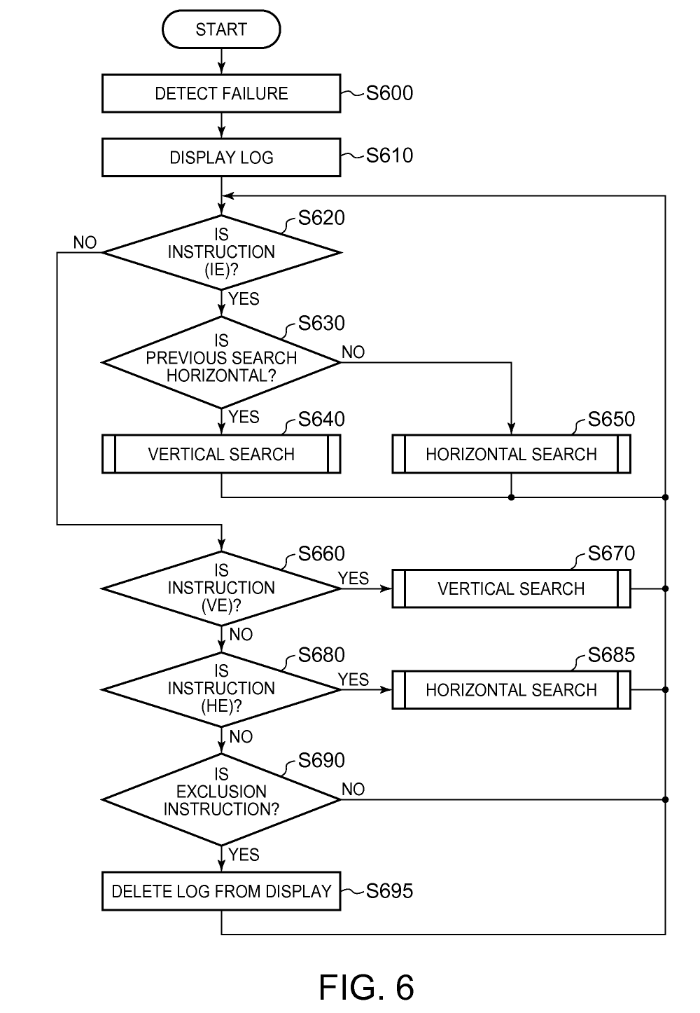

FIG. 6 shows a flowchart of a process for gradually extending the range of logs to be displayed. The failure detection unit 210 detects a component of the information system 10 in which a failure occurred, based on a warning received from the failure monitoring system of the information system 10 (S600). In response to the detection of the failing component, the log display unit 220 reads a log of past events for the component from the log DB 225, and displays the log for a user (S610). Thereafter, the log display unit 220 accepts an instruction from a user who read the log of the failing component to display a log for another component.

When the received instruction is an instruction (IE) for a search for which no direction is designated, the selection unit 230 determines whether or not a direction of a previous search was horizontal (S630). When the direction of the previous search was horizontal (YES at S630), the selection unit 230 selects a component that is adjacent to the previously selected candidate component on a dependency graph in a direction differing from that for the previous instruction, i.e., via a vertical link, as a new candidate component (S640). On the other hand, when the search direction was not horizontal (NO at S630), the selection unit 230 selects a component that is adjacent to the previously selected candidate component on the dependency graph via a horizontal link, as a new candidate component (S650). And when no instruction was previously issued, i.e., when this is the first instruction, it is preferable that the selection unit 230 select an adjacent component via a vertical link, as a candidate component because, in most cases, a component operating in the same information processing unit has more relevancy to the previously selected component than a component operating in a different information processing unit, and the log analysis process can be more easily performed.

Further, the selection unit 230 selects, in response to an instruction (VE) for searching for a failure cause vertically (YES at S660), a component that is adjacent either to the failing component or to the previously selected candidate component on the dependency graph via a vertical link, as a new candidate component (S670). Furthermore, the selection unit 230 selects, in response to an instruction (HE) for searching for a failure cause horizontally (YES at S680), a component that is adjacent either to the failing component or to the previously selected candidate component on the dependency graph via a horizontal link, as a new candidate component (S685).

Next, the selection exclusion unit 250 determines whether or not an instruction has been received from the user to exclude a certain component from the candidate components (S690). When an exclusion instruction has been received (YES at S690), the selection exclusion unit 250 excludes a component designated by the user from the candidate components, and the display control unit 240 deletes the log for the excluded component from the display of the log display unit 220 (S695).

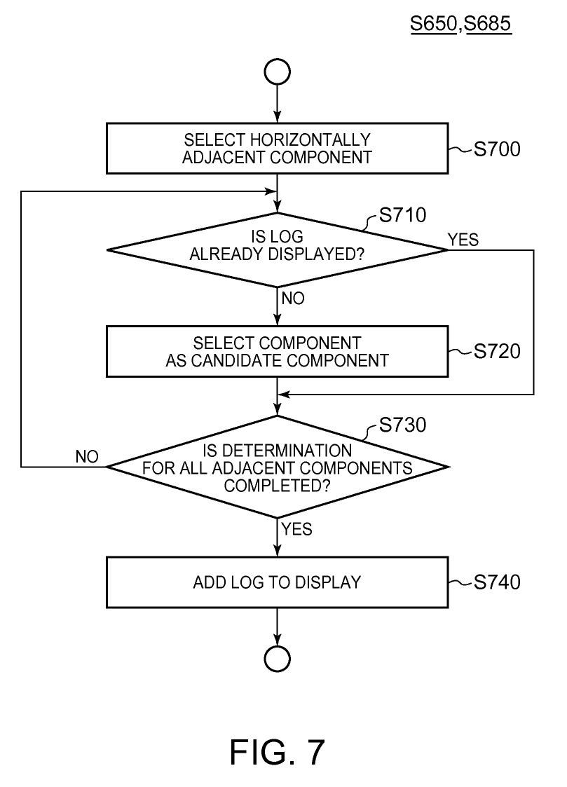

FIG. 7 shows a flowchart of a process for horizontally expanding a search range. First, in the step of S650 or S680, the selection unit 230 selects all the components that are adjacent either to a failing component or a previously selected candidate component on the dependency graph via the horizontal links (S700). The selection unit 230 may select each component adjacent only to a candidate component that the user has selected in advance, for example, by clicking with a mouse, or each component adjacent to any of candidate components.

Further, a component may be determined to be adjacent to a certain component based on an attribute stored in the dependency graph storage unit 200 in association with a link, or based on a direction of the link when the link is a directed link That is, for example, when a failure detected by the failure detection unit 210 is a failure of communication under a certain communication protocol (e.g., a TCP/IP protocol), the selection unit 230 may select only a component that is adjacent via a link that employs the communication protocol as an attribute. When a certain component is connected to a different component via a directed link, the selection unit 230 may select the different component as a component adjacent to the certain component, and does not select the certain component as a component adjacent to the different component. As described above, by effectively employing the attributes and directions associated with the links, the search range for a failure cause can be narrowed down, and a load imposed on the succeeding analysis process can be reduced.

Then, the selection unit 230 determines, for each of the selected components, whether or not a log of that component has been displayed (S710). When the log of a certain component has not yet been displayed (NO at S710), the selection unit 230 selects this component as a new candidate component (S720).

In a case where a failure having a severity value equal to or greater than a predetermined reference value has not yet occurred, even when a log for a component has not yet been displayed, the selection unit 230 need not select the component as a new candidate component. For example, the selection unit 230 reads a log for each of the adjacent components from the log DB 225, and then reads severity values of failures corresponding to the events recorded in the log. Then, when the severity values of all the events that are read for a certain component are equal to or lower than the reference value, the selection unit 230 does not select the certain component as a candidate component. This is because a component in which even a trivial failure has not occurred is rarely considered to be the location of a root cause of a failure. Here, the severity value indicates how severe or serious a failure is.

When the determination for all the adjacent components is completed (YES at S730), the display control unit 240 reads from the log DB 225 a log of events that occurred in the newly selected candidate component, and additionally displays the log on the log display unit 220 (S740). When there is any component for which the determination has not yet been performed (NO at S730), the selection unit 230 returns the process to S710.

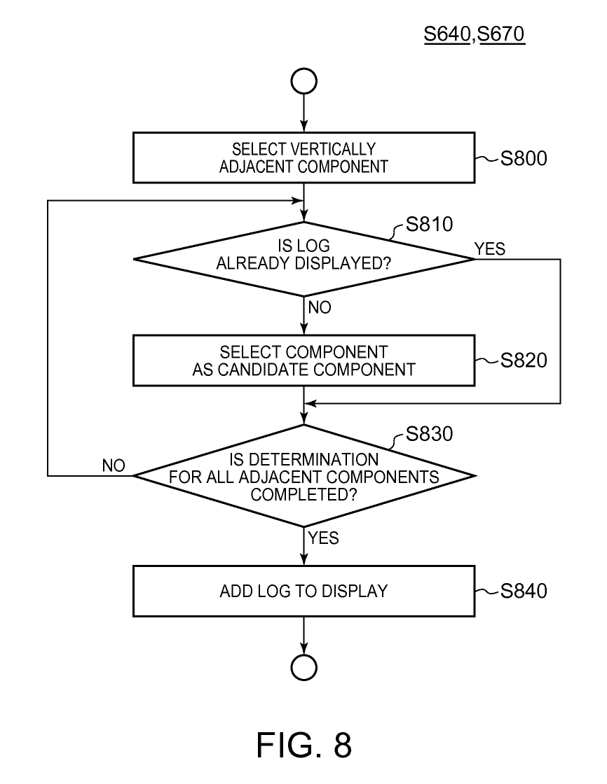

FIG. 8 shows a flowchart of a process for vertically expanding the search range. First, in the step of S640 or S670, the selection unit 230 selects all the components that are adjacent to a failing component or a previously selected candidate component on the dependency graph via the vertical links (S800). The selection unit 230 may select each component adjacent only to a candidate component that the user has selected in advance, by clicking with a mouse, or each component adjacent to any of candidate components.

Then, the selection unit 230 determines, for each of the selected components, whether or not a log of that component has been displayed (S810). When a log of a certain component has not yet been displayed (NO at S810), the selection unit 230 selects the certain component as a new candidate component (S820). When the determination for all the adjacent components has been completed (YES at S830), the display control unit 240 reads a log of events that occurred in the new candidate component from the log DB 225, and displays the log on the log display unit 220 (S840). When there is any component for which the determination has not yet been performed (NO at S830), the selection unit 230 returns the process to S810).

As explained with reference to FIGS. 1 to 8, according to the support system 20 of this embodiment, the dependency relationship of components is visually presented for a user by employing a three-dimensional structure, and the user is enabled to designate the vertical search and the horizontal search distinctly. Further, the range of components for displaying logs can be gradually extended, as instructed by a user, centering around a failing component. Furthermore, a log for a selected component is divided into log segments with respect a predetermined period, which are symbolized, arranged in a time sequence and displayed. Therefore, the user can recognize relationships between components by classifying them into dependency relationships in vertical and horizontal directions, and can employ these relationships as a guide for the referring order of the logs. In addition, the user can refer to necessary information depending on a stage of the investigation of a failure cause by sequentially adding the information when required.

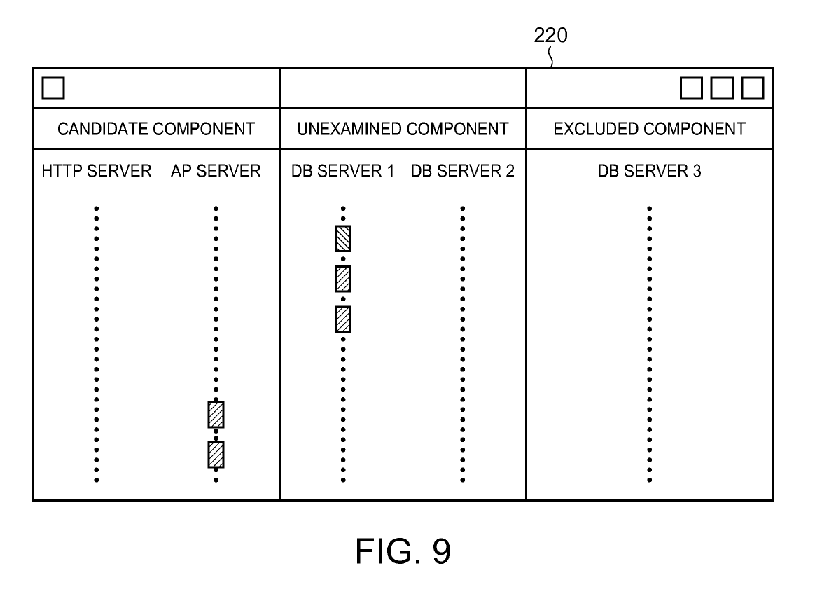

FIG. 9 shows an example of display on the log display unit 220 according to a modified embodiment This example is a modification of the example shown in FIG. 5, where each component to be displayed is prioritized based on an instruction by a user. Specifically, the display control unit 240 gives priority in the order of a previously selected candidate component, a component that was not selected as a candidate component, and a component that was selected as a candidate component but was then excluded, and displays these components on the log display unit 220 after classifying them from left to right. Specifically, since an HTTP server program (HTTP server) and a web application server program (AP server) are selected as candidate components, the display control unit 240 displays symbols indicating the logs of these components after classifying them in the left side of the screen with the first priority level. On the other hand, since DB server program 1 (DB server 1) and DB server program 2 (Db server 2) were not selected as candidate components, the display control unit 240 displays symbols indicating the logs of these components after classifying them in the middle of the screen with the second priority level. Finally, since DB server program 3 (DB server 3) was selected as a candidate component and was then excluded, the display control unit 240 displays symbols indicating the log of this component after classifying them in the right side of the screen with the third priority level. In this manner, a log or its symbol may be classified and displayed according to its priority level that is selected by the user. With this arrangement, not only an important log for finding a failure cause can be identified on the display, but also a log of a component that was excluded from selection as a candidate and has a low importance level, can be displayed on the screen.

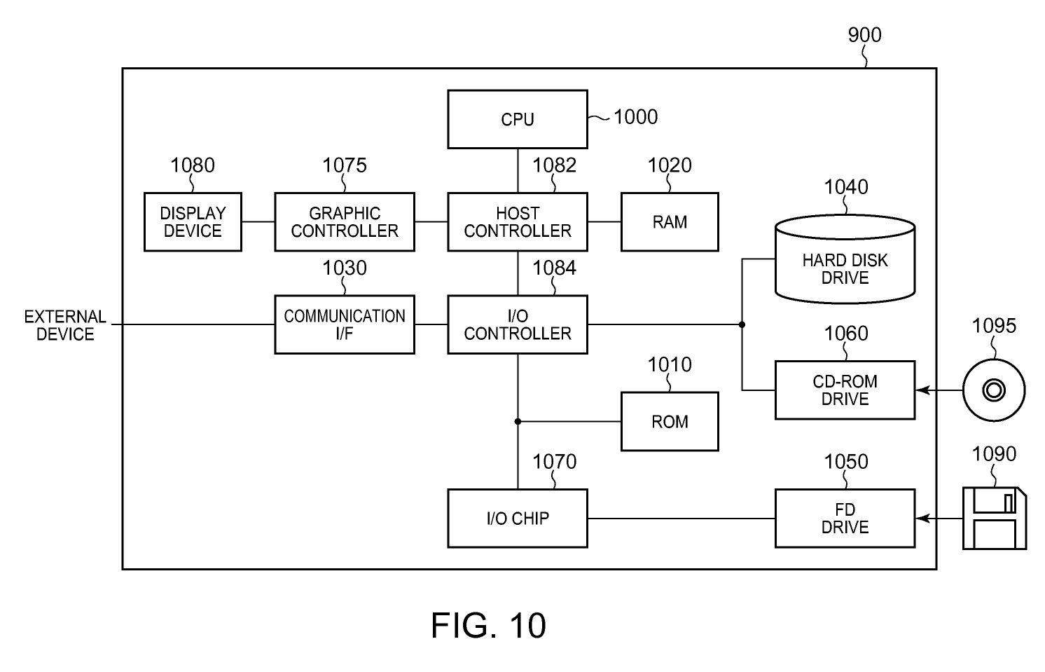

FIG. 10 shows an example of a hardware configuration of an information processing system 900 that serves as a support system 20. The information processing system 900 comprises a CPU related section including a CPU 1000, a RAM 1020 and a graphic controller 1075 that are interconnected by a host controller 1082, an input/output section including a communication interface 1030, a hard disk drive 1040 and a CD-ROM drive 1060 that are connected to the host controller 1082 by an input/output controller 1084, and a legacy input/output section including a ROM 1010, a flexible disk drive 1050 and an input/output chip 1070 that are connected to the input/output controller 1084.

The host controller 1082 connects the RAM 1020 to the CPU 1000, which accesses the RAM 1020 at a high transfer rate, and the graphic controller 1075. The CPU 1000 operates based on programs stored in the ROM 1010 and the RAM 1020, and controls each section. The graphic controller 1075 obtains image data that the CPU 1000, for example, generates in a frame buffer provided in the RAM 1020, and displays the image data on a display device 1080. Alternatively, this frame buffer may be provided in the graphic controller 1075.

The input/output controller 1084 connects the host controller 1082 to the communication interface 1030, the hard disk drive 1040 and the CD-ROM drive 1060, which are relatively fast input/output devices. The communication interface 1030 communicates with an external device through a network The hard disk drive 1040 is used to store programs and data employed by the information processing system 900. The CD-ROM drive 1060 reads a program or data from a CD-ROM 1095, and transmits it to the RAM 1020 or the hard disk drive 1040.

Further, the ROM 1010 and relatively slow input/output devices, such as the input/output chip 1070 and the flexible disk drive 1050, are connected to the input/output controller 1084. The ROM 1010 is used to store, for example, a boot program that the CPU 1000 executes at startup time of the information processing system 900, and a program that depends on the hardware of the information processing system 900. The flexible disk drive 1050 reads a program or data from a flexible disk 1090, and provides it through the input/output chip 1070 to the RAM 1020 or the hard disk drive 1040. The input/output chip 1070 connects the flexible disk 1090 or various types of input/output devices via, for example, a parallel port, a serial port, a keyboard port and a mouse port.

A program for the information processing system 900 is stored on a recording medium such as the flexible disk 1090, the CD-ROM 1095 or an IC card, and is provided by a user. The program is read from the recording medium via the input/output chip 1070 and/or the input/output controller 1084, and is installed into and executed by the information processing system 900. Since the program enables the information processing system 900 to perform the same operation as that performed by the support system 20 explained with reference to FIGS. 1 to 9, no further explanation for this will be given.

The above described program may be stored on an external storage medium. The storage medium is not only the flexible disk 1090 or the CD-ROM 1095, but also can be an optical recording medium, such as a DVD or a PD, a magneto-optical recording medium, such as an MD, a tape medium, or a semiconductor memory, such as an IC card. Also, a storage device, such as a hard disk or a RAM, provided in a server system connected to a dedicated communication network or the Internet may be employed as a recording medium, and the program can be provided via the network to the information processing system 900.

While the present invention has been described by employing the embodiment, the technical scope of the invention is not limited to the embodiment, and it is obvious for one having the ordinary skill in the art that the embodiment can be variously modified or improved. It is also obvious from the appended claims that such modifications or improvements are also included in the technical scope of the present invention.

What is claimed is:

1. A support system for supporting finding of a location of a cause of a failure occurrence in an information system that includes a plurality of components, comprising:
a storage unit for storing a dependency graph in which components are expressed as nodes and relationships of components depending directly on each other are expressed with links;
a log display unit for displaying, in response to detection of a failing component, a log of events occurring in the component;
a selection unit for selecting, in response to an instruction by a user, a component that is adjacent to the failing component on the dependency graph, as a candidate component for a failure cause; and
a display control unit for enabling the log display unit to additionally display a log of events occurring in the selected candidate component;
wherein the selection unit further selects, in response to an instruction by a user, a component that is adjacent to the candidate component on the dependency graph as a new candidate component, on condition that a log thereof has not yet been displayed.

2. The support system according to claim 1, wherein
the information system includes a plurality of information processing units,
each component serves as at least a part of hardware of one of the information processing units, or as at least a part of software operating in one of the information processing units,
the storage unit stores the dependency graph including a vertical link that represents a relationship of components in which one component among a plurality of components operating in the same information processing unit operates in dependence on the operation of another component, and a horizontal link that represents a relationship of a plurality of components operating in different information processing units and communicating with each other,
the selection unit selects, in response to an instruction for vertically searching for a failure cause, a component that is adjacent to the failing component or the previously selected candidate component on the dependency graph via a vertical link, as a new candidate component, and
the selection unit selects, in response to an instruction for horizontally searching for a failure cause, a component that is adjacent to the component in which the failure occurred or the previously selected candidate component on the dependency graph via a horizontal link, as a new candidate component.

3. The support system according to claim 2, wherein the selection unit selects, in response to a search instruction that designates no direction, a component that is adjacent to the already selected component on the dependency graph via a link having a direction differing from the one previously instructed, as a new candidate component, so that a vertical search and a horizontal search are alternately repeated each time the instruction is issued.

4. The support system according to claim 1, wherein the selection unit does not select a component that is adjacent to the previously selected candidate component on the dependency graph as a new candidate component, on condition that a failure having a severity value equal to or greater than a predetermined reference value does not occur in the component.

5. The support system according to claim 1, wherein
the storage unit stores links expressing relationships of components depending on each other, in association with attributes representing link types, and
the selection unit selects a component that is adjacent to the failing component or the previously selected candidate component via a link corresponding to an attribute that is associated in advance with a type of the failure occurred, as a new candidate component.

6. The support system according to claim 1, further comprising a selection exclusion unit for excluding a component that is designated by a user from components that are selected as candidate components and logs of events thereof are displayed,
wherein the display control unit deletes a log of the component excluded from the candidate components, from display provided by the log display unit.

7. The support system according to claim 1, wherein the log display unit displays, for each component, symbols arranged in the order of occurrence of the events, the symbols indicating severity of failures recorded in log segments that are formed by dividing a log of events with respect to a predetermined period of time, and the log display unit further displays, in response to an instruction received from a user to select a symbol, a log segment that is represented by the selected symbol.

8. The support system according to claim 1, further comprising a selection exclusion unit for excluding a component that is designated by a user from components that are selected as candidate components and logs of events thereof are displayed,
wherein the display control unit gives priority in the order of a selected candidate component, a components that was not selected as a candidate component, and a component that was selected as a candidate component and was thereafter excluded from candidate components, and displays their logs of events on the log display unit.

9. The support system according to claim 1, wherein
the storage unit stores the dependency graph including a monitoring link distinguished from the other links, the monitoring link representing a relationship in which a monitoring agent, which is a program for monitoring whether or not a failure occurs in a component, transmits monitoring results to a monitoring server program that collects monitoring results, and
the selection unit selects, in response to an instruction to search for a failure cause via the monitoring link, a component that is adjacent to the monitoring agent that monitors a failing component or a candidate component, on the dependency graph via the monitoring link, as a candidate component.

10. A method for supporting finding of a location of a cause of a failure occurrence in an information system that includes a plurality of components, comprising the steps of:
storing a dependency graph in which components are expressed as nodes and relationships of components depending directly on each other are expressed with links;
displaying, in response to detection of a failing component, a log of events occurring in the component;
selecting, in response to an instruction by a user, a component that is adjacent to the failing component on the dependency graph, as a candidate component for a failure cause;
displaying a log of events occurring in the selected candidate component;
selecting, in response to an instruction by a user, a component that is adjacent to the candidate component on the dependency graph as a new candidate component, on condition that a log thereof has not yet been displayed; and
further displaying a log of events occurring in the selected candidate component.

11. A computer program product comprising computer program code recorded on a computer-readable recording medium, for causing an information processing system to serve as a support system for supporting finding of a location of a cause of a failure occurrence in an information system that includes a plurality of components, the program causing the information processing system to function as:
a storage unit for storing a dependency graph in which components are expressed as nodes and relationships of components depending directly on each other are expressed with links;
a log display unit for displaying, in response to detection of a failing component, a log of events occurring in the component;
a selection unit for selecting, in response to an instruction by a user, a component that is adjacent to the failing component on the dependency graph, as a candidate component for a failure cause; and
a display control unit for enabling the log display unit to additionally display a log of events occurring in the selected candidate component;
wherein the selection unit selects, in response to an instruction by a user, a component that is adjacent to the candidate component on the dependency graph, as a new candidate component, on condition that a log thereof has not yet been displayed.
